(19) United States
(12) Patent Application Publication
(10) Pub. No.: US 2017/0048670 A1
(43) Pub. Date: Feb. 16, 2017

(54) SYSTEMS AND METHODS FOR LOCATION-DEPENDENT ELECTRONIC COMMUNICATIONS

(71) Applicants: Dave WEIK, Arlington, MA (US); Jared CIRCOSTA, Boston, MA (US); Jennifer DADAGIAN, Hopkinton, MA (US); Mike DINICOLA, Brighton, MA (US); Geoff DONEGAN, Arlington, MA (US); Taylor FINCKE, Charlestown, MA (US); TANK DESIGN, INC., Cambridge, MA (US)

(72) Inventors: Dave Weik, Arlington, MA (US); Jared Circosta, Boston, MA (US); Jennifer Dadagian, Hopkinton, MA (US); Mike Dinicola, Brighton, MA (US); Geoff Donegan, Arlington, MA (US); Taylor Fincke, Charlestown, MA (US)

(21) Appl. No.: 15/307,577

(22) PCT Filed: May 8, 2015
(86) PCT No.: PCT/US15/29970

§ 371 Date: Oct. 28, 2016

Related U.S. Application Data
(60) Provisional application No. 61/990,342, filed on May 8, 2014.

(51) Int. Cl. H04W 4/02; G06F 17/30

(52) U.S. Cl. CPC H04W 4/021; G06F 17/30241; G06F 17/30058; G06F 17/30041; H04W 4/12

(57) ABSTRACT

A system and method for preparing and delivering media assets according to location is provided. A user may prepare, using a computing device, a media asset including images, text, video, audio, symbols, or other content, and specify one or more recipient(s) and a location for delivery. The media asset is then stored in a database, and made available to the recipient when the recipient's computing device arrives at the specified location. The delivery may be further controlled by setting time, date, and other parameters. Thus, a user may accomplish the targeted delivery of customized content according to a recipient's location and other desired characteristics. Alternatively, a media asset may be delivered to an anonymous group of recipients upon their reaching a specified location.

### CROSS-REFERENCE TO RELATED APPLICATIONS

This application claims the benefit of U.S. Provisional Patent Application No. 61/990,342, filed May 8, 2014, which is incorporated herein by reference in its entirety.

### COPYRIGHT

A portion of the disclosure of this patent document contains material which is subject to copyright protection. The copyright owner has no objection to the facsimile reproduction by anyone of the patent disclosure, as it appears in the Patent and Trademark Office patent files or records, but otherwise reserves all copyright rights whatsoever.

### TECHNICAL FIELD

Aspects of the present disclosure are directed to systems and methods that allow users or companies/brands to send electronic communications containing media assets (such as text, images, audio, video, etc.) to other users, where the communications are delivered according at least to the recipients' geolocation.

### BACKGROUND

There are many ways to communicate information using computing devices, such as mobile phones and similar devices. These communications may be nearly instantaneous, in that the intended recipients immediately, or nearly immediately, receive the desired information. As a result, the communication may not be provided at a time or place most desirable or useful to the recipient. For these and other reasons, it is highly desirable to provide a way to control the delivery of selected communications such that the message is delivered at a time and/or place where it will be most useful or appropriate for the recipient. Thus, the systems and methods disclosed herein provide the ability to target the delivery of customized communications by location, time and additional parameters.

### SUMMARY

According to aspects of the present disclosure, a system for location-based delivery of media assets is provided, the system having a database, a first computing device, and a second computing device. The first computing device is in communication with the database, and has a memory storing instructions, and processor(s) executing the instructions to allow for the preparation of a media asset. The preparation of a media asset includes creation of content for the media asset, selection of a geolocation for delivery of the media asset, and selection of one or more recipients for the media assets. Once prepared, the first computing device stores the media asset in the database. A second computing device, having a memory storing instructions, a geolocation capability, and processors(s) executing the instructions is also in communication with the database. The second computing device determines, via the geolocation capability, the current location of the second computing device, and identifies, via communication with the database, one or more media assets associated with the current location, and presents the media asset(s) on the second computing device.

According to further aspects of the present disclosure, a method for creation and delivery of customized communications is disclosed. According to the method, a customized communication comprising one or more of audio, video, image, symbol, or textual content is created on a first computing device. A selection of geolocation for delivery of the customized content is received by the first computing device. The first computing device then stores the information relating to the communication in a database. A second computing device, in communication with the database, determines its current location using a geolocation capability associated with the second computing device, and determines via the database if a customized communication is associated with the current location. If so, the communication is presented on the second computing device.

These and other capabilities of the invention, along with the invention itself, will be more fully understood after a review of the following figures, detailed description, and claims.

### BRIEF DESCRIPTION OF THE DRAWINGS

FIG. 1 illustrates an exemplary application of the disclosure, according to an embodiment of the present disclosure.

FIG. 2 illustrates the creation of a media asset, according to an embodiment of the present disclosure.

FIG. 3 illustrates the selection of a location for a media asset, according to an embodiment of the present disclosure.

FIG. 4 illustrates the selection of additional parameters for a media asset, according to an embodiment of the present disclosure.

FIG. 5 illustrates existing media assets by location, according to an embodiment of the present disclosure.

FIGS. 6a-6g illustrate exemplary screen flows on a mobile device, according to an embodiment of the present disclosure.

FIG. 7 is a flowchart of a media asset creation and management process, according to an embodiment of the present disclosure.

FIG. 8a illustrates an exemplary application homepage, according to an embodiment of the present disclosure.

FIG. 8b illustrates an exemplary media asset creation page, according to an embodiment of the present disclosure.

FIG. 8c illustrates an exemplary target selection page, according to an embodiment of the present disclosure.

FIG. 8d illustrates an exemplary additional parameter selection page, according to an embodiment of the present disclosure.

FIG. 8e illustrates an exemplary location selection page, according to an embodiment of the present disclosure

While the invention is susceptible to various modifications and alternative forms, specific embodiments have been shown by way of example in the drawings and will be described in detail herein. It should be understood, however, that the invention is not intended to be limited to the particular forms disclosed. Rather, the invention is to cover all modifications, equivalents, and alternatives falling within the spirit and scope of the invention as defined by the appended claims.

### DETAILED DESCRIPTION

While the invention is susceptible of embodiment in many different forms, there is shown in the drawings and will herein be described in detail preferred embodiments with the understanding that the present disclosure is to be considered as an exemplification of the principles of the invention and is not intended to limit the broad aspect of the invention to the embodiments illustrated. For purposes of the present detailed description, the singular includes the plural and vice versa (unless specifically disclaimed); the words “and” and “or” shall be both conjunctive and disjunctive; the word “all” means “any and all”; the word “any” means “any and all”; and the word “including” means “including without limitation.” Additionally, the singular terms “a,” “an,” and “the” include plural referents unless context clearly indicates otherwise.

Aspects of the present disclosure are directed to systems and methods that allow users or companies/brands to send electronic communications containing media assets to other users, where the communications are delivered according to at least the recipients' geolocation.

According to aspects of the present disclosure, embodiments employ one or more web service(s), database(s), and application(s) that are executed on a computing device. In some embodiments, the computing device may be a portable device, such as a smart phone or other smart device, such as a computer tablet, watch, etc., and the application may be a mobile application. In particular, the application may use utilities, sensors, etc., provided by the computing device (e.g., GPS or other location services) to detect or identify geolocation and obtain other information, such as time-related information. Geolocation information may include, for example, latitude and longitude, altitude, heading, and speed.

The user specifies one or more geolocations to be associated with a media asset, by tagging the media asset using utilities, sensors, or other location-based capabilities provided by the computing device. The user does not have to be at the physical location that corresponds to the tag for the media asset. Using the application and communications provided by the computing device, the user sends the media asset to the database through the web service. The database stores the media asset and makes the media asset available for other users of the application to retrieve.

In real time, the application(s) on computing device(s) of other user(s) match information provided by the application(s) and/or the computing device(s) against the media asset data stored in the database. The matching may evaluate user information, geolocation, time, and other parameters.

A user receives a media asset in real time when a match determines that the user is the intended recipient at the designated geolocation, time, etc. In some embodiments, when the match takes place, the recipient receives a notification through the application, allowing them to retrieve the media asset. The notification may include indicators for other recipients, allowing a user to easily see who else has collected the media asset, or are on the recipient list but have not yet collected the media asset. In some embodiments, the notification allows the user to view the media asset, or save for later viewing. Additionally, the notification options may be configurable, to allow for notifications with or without sound, how many notifications to display, whether to display notices when the computing device is locked, etc. In still other embodiments, the notifications and/or the media asset itself may be shared within the application or via third party social media website, and liked, commented on, etc. One such capability allows a recipient, upon receiving the asset, to quickly reply back to the sender of a media asset. When a recipient receives a media asset, a notification may also be provided to the user who left the asset for the recipient.

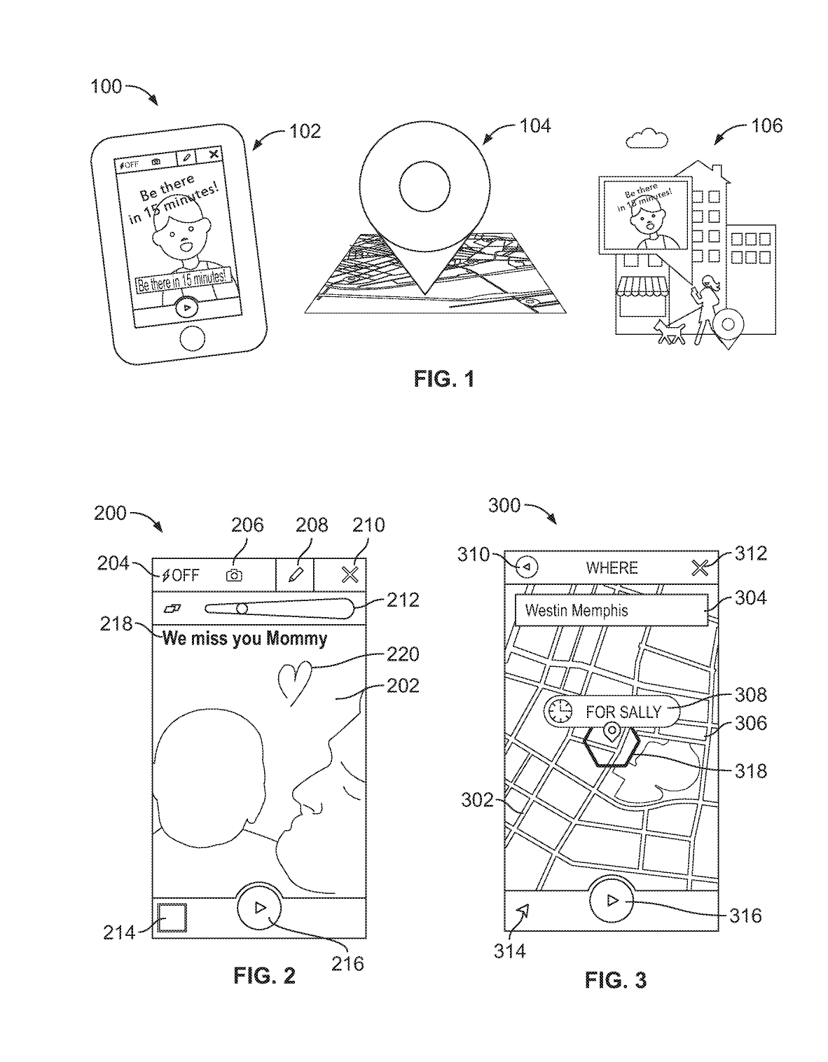

Referring to FIG. 1, an example use case 100 is provided. At 102, a user creates a custom message with text, images, audio, video, etc.; shown here, the user selects a photo and adds the message “Be there in 15 minutes!” At 104, the user drops a pin at the geolocation where the custom message should be delivered. According to some embodiments, multiple geolocations may be associated with the message. At 106, the recipient's mobile device receives the picture including the “be there in 15 minutes” text upon reaching the selected geolocation.

According to some embodiments, additional restrictions may be placed on delivery, such as time, to allow a user to further restrict delivery. This allows the user to have additional flexibility to manage delivery for frequented geolocations by the recipient, for example, a message intended for receipt by a friend arriving home after work could select the location of the friend's home combined with a 5:00 pm start time.

Using the application, a user can create a media asset as shown in FIG. 2. The media asset may be created to contain text, symbols, audio, images, video, or other content, or a combination thereof. As shown in FIG. 2, the user has created a media asset by adding customized content to a previously existing image 202 (here, a photo of a father and baby). According to some embodiments, the image is selected from existing images on the user's device (e.g. using the file selector icon 214); alternatively, a photo may be taken (by selecting the photo icon 206) and used in the media asset. Additional editing functions are available through selection of the edit icon 208. Using the editing functions, the user further customizes the media asset by adding a drawing of a heart 220, and the text “we miss you mommy” 220, to the photo 202. According to some embodiments, the application additionally allows the user to select audio files, record audio messages, capture or select existing video files, or add other content to the message, when creating the media asset.

Turning to FIG. 3, the user can select the geolocation where they want to leave the media asset to be received. At 302, a map is shown to assist in selecting a location. At 304, a search interface is provided to allow for a location to be typed in (here, “Westin Memphis”). When an address or location is entered into the search interface 304, the map 302 is updated accordingly, and the location indicator 306 is moved to the appropriate location. According to some embodiments, the map 302 shows the media asset collection area 318 and, additionally, may allow the collection area 318 to be adjusted.

At 306, a location indicator is shown on the map to confirm the associated location for the media asset. According to some embodiments, related information 308 such as the recipient's name, time restriction(s), or privacy settings are also shown in association with the location indicator 306.

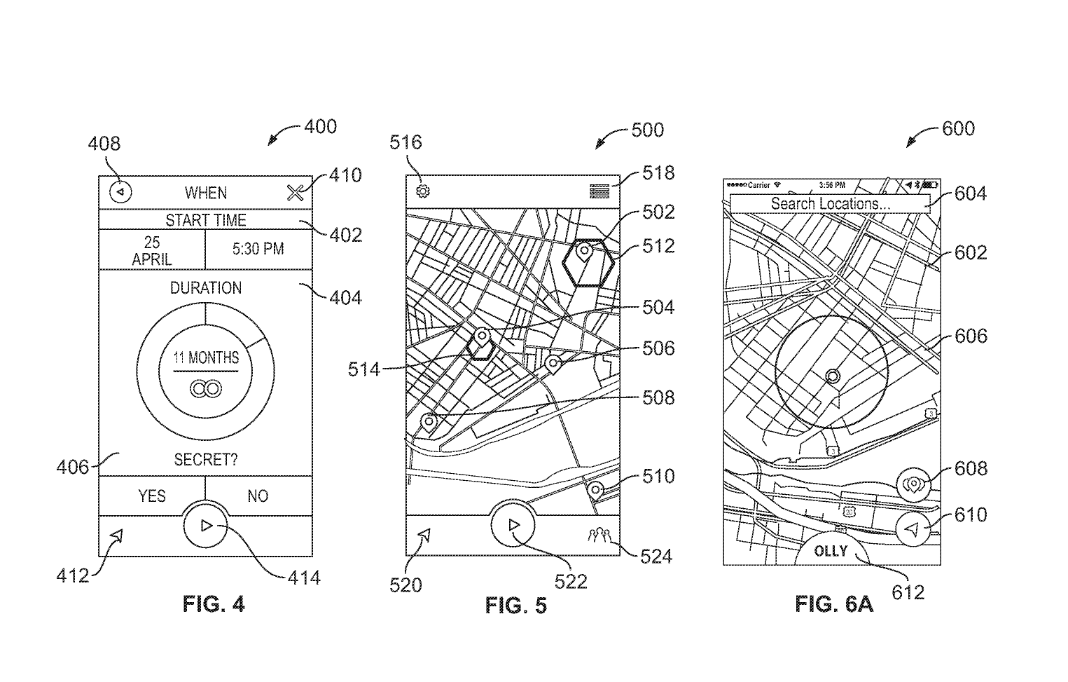

Turning to FIG. 4, an exemplary selection of related information is shown. At 402, the user may select and adjust date and time information. If no time or date is selected, the media asset will be immediately available once left for the recipient(s). At 404, the duration of the message may be selected. If a finite duration is set, the media asset will expire if not delivered by that time. Alternatively, the user may select infinite duration. At 406, the media asset may be set to secret if desired. If the media asset is not secret, the media asset appears on the map and the recipient(s) may receive notification that the asset is available at the selected geolocation. If the media asset is secret, it does not appear on the map and no notification is provided. According to an alternative embodiment, the secret media asset is not shown on the map, but a notification is provided to recipients without any location information. Additionally, in some embodiments, an optional mode can be enabled to notify the user how close they are to the nearest secret media asset.

Turning to FIG. 5, geolocations of media assets 502. 504, 506, 508, and 510 are shown on a map interface 500. As shown on the map interface 500, location of media asset 502 is associated with media asset collection area 512, and location of media asset 504 is associated with media asset collection area 514. The interface 500 may show media assets the user has created for others, media assets created by others to be received by the user, or both. The map interface will also show public media assets if desired. According to some embodiments, these settings are configurable.

Thus, the user can use the application to view their current location, view public media assets, view private media assets for the user, view media asset details, filter the map, receive notifications and media assets, create and leave media assets, and personalize their settings as desired. In some embodiments, the capability to edit the delivery settings for a previously left but uncollected media asset is provided. For example, the location may be broadened or modified, and time restrictions removed for an uncollected media asset (but the media asset content remains unchanged). Additionally, an existing asset can be left for additional recipients if desired. For a first time user, the application provides context based coaching information to train the user on the application's many capabilities.

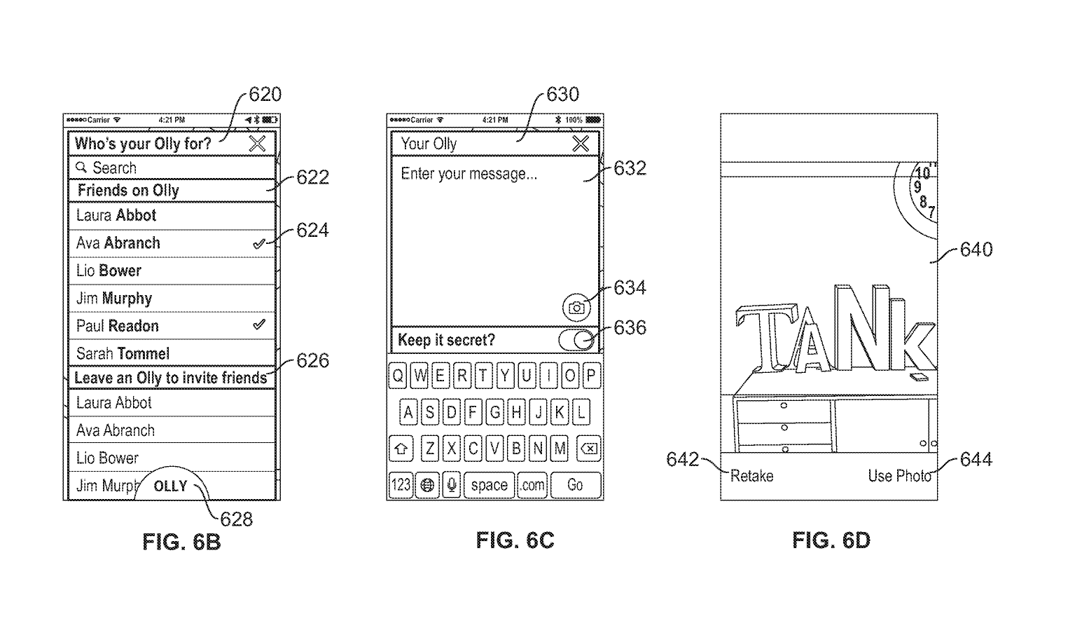

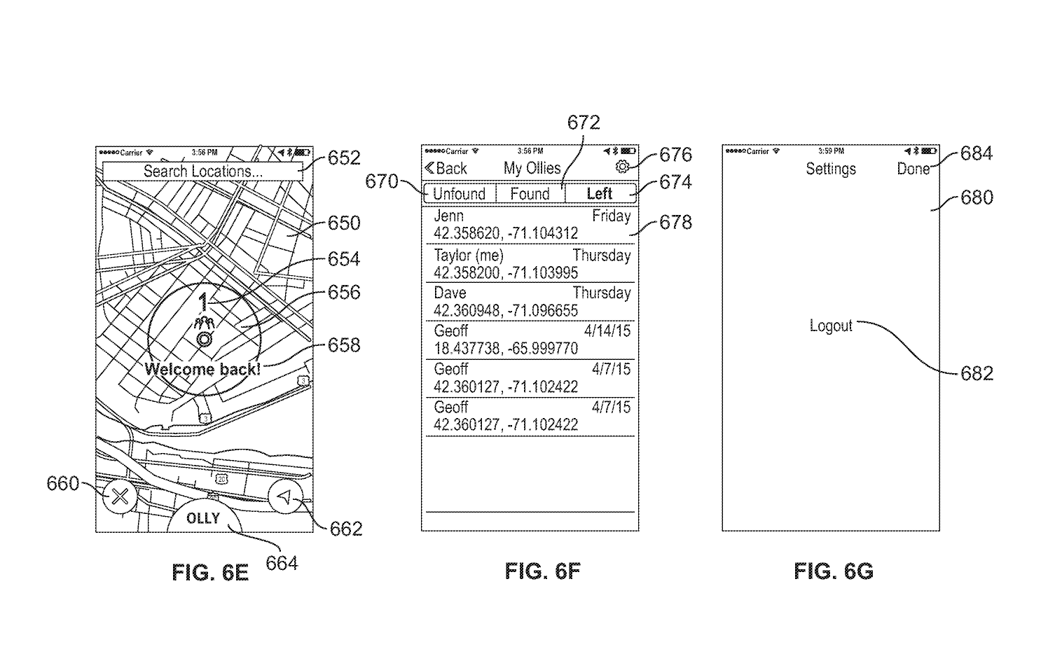

Turning next to FIGS. 6a-6g, screen captures of a mobile device running the application are provided, according to an embodiment of the present disclosure. In FIG. 6a, the main application display is shown. At 602, a map is provided for location selection of the media asset. At 604, a text based search field is provided. In some embodiments, the user's current location 606 is shown. A listing of media assets may be displayed by selecting icon 610, as discussed further below in association with FIG. 6f. The map can be zoomed in or out using the standard functions of the mobile device. At 608, a marker icon allows a user to select the option to add location marker(s) to the map. Once one or more locations have been selected for delivery, at 612, the “OLLY” button may be selected to continue the process. After selection of the “OLLY” button 612, the user can choose a recipient for the media asset from a list as shown in FIG. 6b. In some embodiments, the list comprises the user's contacts on the mobile device, social media contacts, or other previously defined contacts. In some embodiments, recipients can be added by phone number or other identifying information. In the displayed embodiment, the recipient list is divided into friends with an account on the application 622, and additional contacts that may be invited to the application 626. An invite may be accomplished by SMS message, email, or similar methods. A selected recipient is indicated by check mark 624 or similar symbol or indicator. In this example, two recipients have been selected to receive the media asset, although additional recipients (or only a single recipient) can be selected if desired. Once the recipient(s) are selected, the user selects the “OLLY” button 628 to continue the process.

Next, at FIG. 6c the user is presented with an opportunity to create the content of the message. At 634, an image may be added by selecting the camera icon. In some embodiments (not shown), additional tools are provided to add video or audio content, draw symbols, or select from additional languages, emoticons, or other expressive elements. According to some embodiments, these tools include, but are not limited to, the standard content capture tools available on the mobile phone or other smart device. At 632, the user may enter a textual message. At 636, the user may select whether the media asset will be treated as secret. If the photo 634 is selected, the photo capture and selection process proceeds as shown in FIG. 6d. If a new image is desired other than the currently displayed image 640, retake 642 is selected and the standard camera tools are available to capture an image. When the desired image 640 is for the media asset is shown, then use photo 644 is selected and the process proceeds to FIG. 6e.

Once the media asset is created, the user is presented with FIG. 6e, which allows the user to review the media asset and confirm the number of recipients 654, content 658, and location 656. Here, the user has previously entered the text “Welcome back” which is shown at 658. If needed, the location 656 or content 658 may be adjusted by selecting within the location area 656. The media asset can be canceled by selecting 660. The selection of “OLLY” 664 will confirm the process, and leave the media asset for the recipient(s) at the selected location.

Referring back to FIG. 6a, selecting the map pin icon 610 will provide access to the listing of the user's media assets as shown in FIG. 6f. By selecting unfound 670, the media assets that have been left for the user by another user, but not yet discovered, are listed. By selecting found 672, the previously discovered media assets left for the user by another user are listed. By selecting left 674, the media assets a user has left for others are listed. According to some embodiments, the media asset information displayed in FIG. 6f can be further sorted by time, date, proximity, contact name, or related information. Additionally, the media asset information can be viewed as a list 678 or in a map view (see, for example, FIG. 5). At 676, additional settings for the application can be accessed, as shown in FIG. 6g. At FIG. 6g, the user is provided the option to logout 682 or select done 684 to end the settings adjustment process. In some embodiments, additional profile settings or other parameters may be accessed or adjusted from this display.

According to aspects of the present disclosure, several scenarios exemplifying potential uses of the embodiments disclosed herein are now detailed, with the understanding that the provided scenarios below are illustrative only, and many additional scenarios, examples, and/or use cases are contemplated by the disclosure.

### “We Miss You Mommy”

In this scenario, Sally is a young professional that travels for work, and her husband Chris and baby Reggie miss her. Chris' goal is to communicate to Sally that they miss her and are thinking of her. So, Chris wants to leave Sally a photo of him and baby Reggie, for her to collect when she arrives at the hotel in Memphis.

To accomplish this task, Chris can select Sally as the recipient, and quickly take a photo and type a message using the application. He may format the style of the typed message if desired. He searches for the Westin in Memphis, where Sally will be staying on her business trip. He selects this location, and decides whether the media asset will be secret or not. If secret is not selected, Sally will receive a notification that a media asset has been left for her at the Westin location. If secret is selected, no notification will be sent to Sally at the time the media asset is left for her, and she will not know about the media asset until she crosses the geofence of the selected Westin Memphis location. Or, according to an alternative embodiment, Sally will receive notice that a media asset has been left, but the location will be undisclosed. Upon arrival at the Westin, Sally will receive the media asset and can reply to or dismiss the asset once received.

### “Promposal”

In this scenario, John, a high school student, wants to ask Alina to the prom. His goal is to use a creative, thoughtful and fun way to ask Alina to the senior prom in a way that will make her feel special. Using the application, John creates a scavenger hunt for Alina, by leaving various media assets for her. The hunt takes her to various meaningful places they have experienced together in their one-year relationship. Each location reveals another “clue” by delivering a media asset. The final clue, which Alina receives when reaching the final location, is the most important—an invitation to go to the senior prom.

### “Media Asset for all My Friends”

In this scenario, Jill, a college student, wants to create a playful and fun message to send her friends. Her goal is to make her friends “LOL.” She selects a frequented location and picks a fun and silly group photo of her college roommates. Her friends receive the photo when they arrive at the frequented location.

### “The ‘Boss’ Show”

In this scenario, Mark is in his twenties and works as a concert promoter on Bruce Springsteen's team. Mark wants to create a reward for loyal fans, so that they feel a connection to the “Boss.” Mark sets up the application to create a public media asset limited to 100 collections, so that the first 100 people to come to a specified location are eligible to collect two free tickets for an upcoming concert.

### “Retailer”

In this scenario, Kelly is a 26 year old junior designer in the advertising industry. She wants to make a client's customers happy, and surprise them with an in-store promotion. Therefore, Kelly uses the application to set up a promotion that allows people who walk in front of the client's store at the mall to receive a media asset offering an instant 20% off in-store coupon.

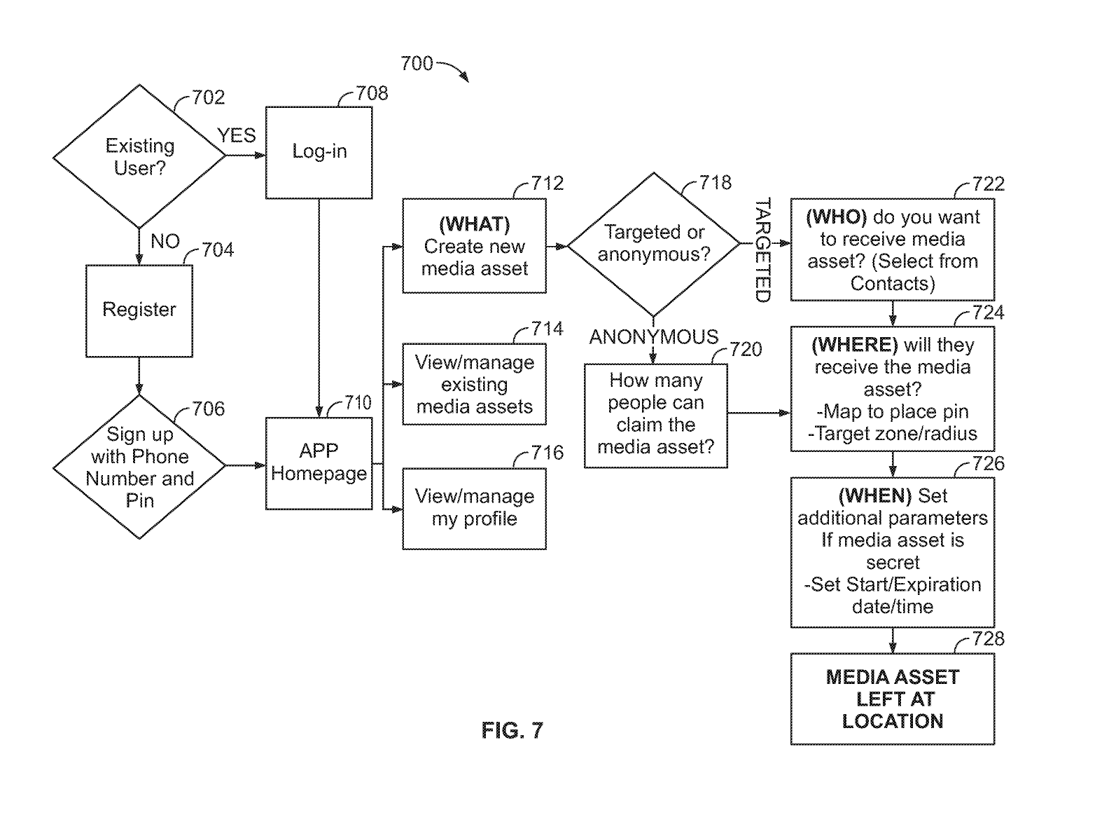

Referring now to FIG. 7, a flowchart 700 for the application is provided. At 702, an existing user can bring up the application homepage 710 by opening the application and, if necessary, logging in 708. If a user's login information does not match a known user in the database, the application will prompt for reentry of username and password, or creation of a new account. At 702, if the user is a first time user, then the user can sign up with their phone number and personal identification number (PIN). At the application homepage 710, the user may select to create a new media asset 712. The user can then create the media asset by adding text, uploading a photo, uploading video, recording a message, etc. According to some embodiments, at 718 the user can select whether the media asset is targeted to specific recipients or anonymous. At 720, for an anonymous asset, the user is asked how many people can claim the asset. Otherwise, at 722 the user selects who should receive the media asset. In some embodiments, the recipients are selected from the contacts database on the mobile device. Next, at 724 the location where the media asset will be received is selected. The disclosure contemplates several methods of identifying the target location: placing a pin on a location on a map, searching for a specific location via the search interface, and/or selecting a target zone (for example, by specifying a proximity radius associated with a location) for delivery. Continuing to 726, additional parameters may be set if desired, including a start date and time, expiration period, and status as secret or normal. At 728, the media asset is left at the selected location.

Referring back to the application homepage 710, the user may also choose to view or manage existing media assets at 714. Also, a profile management page 716 is provided, that allows for change of phone number and PIN information, and selection of other configurable user preferences.

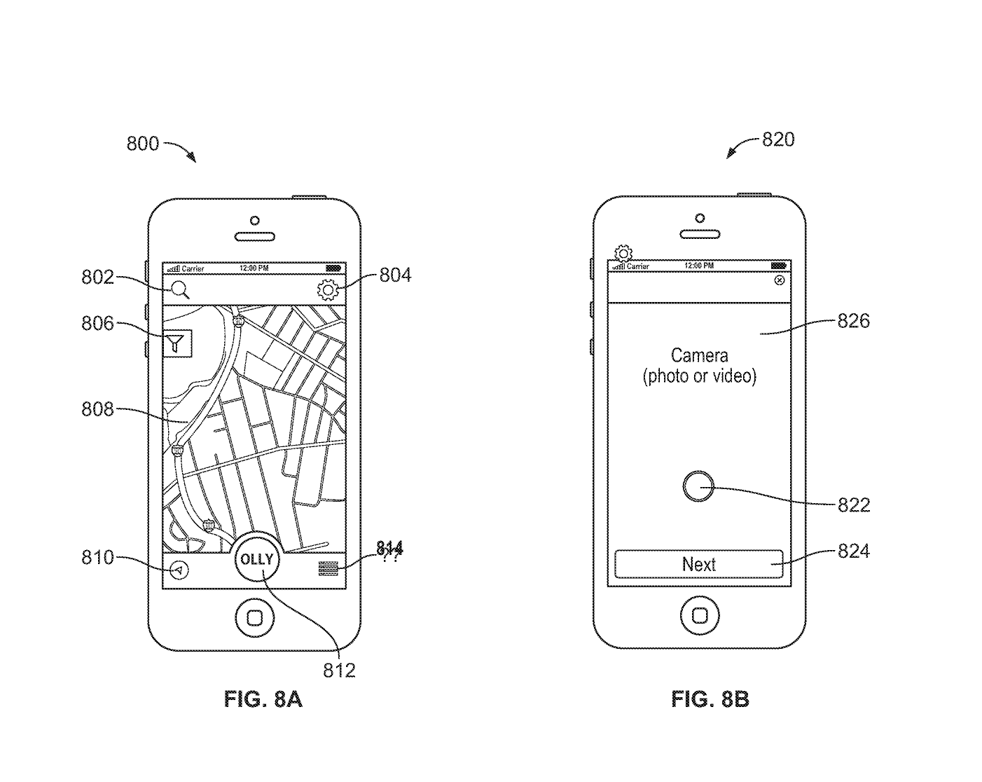

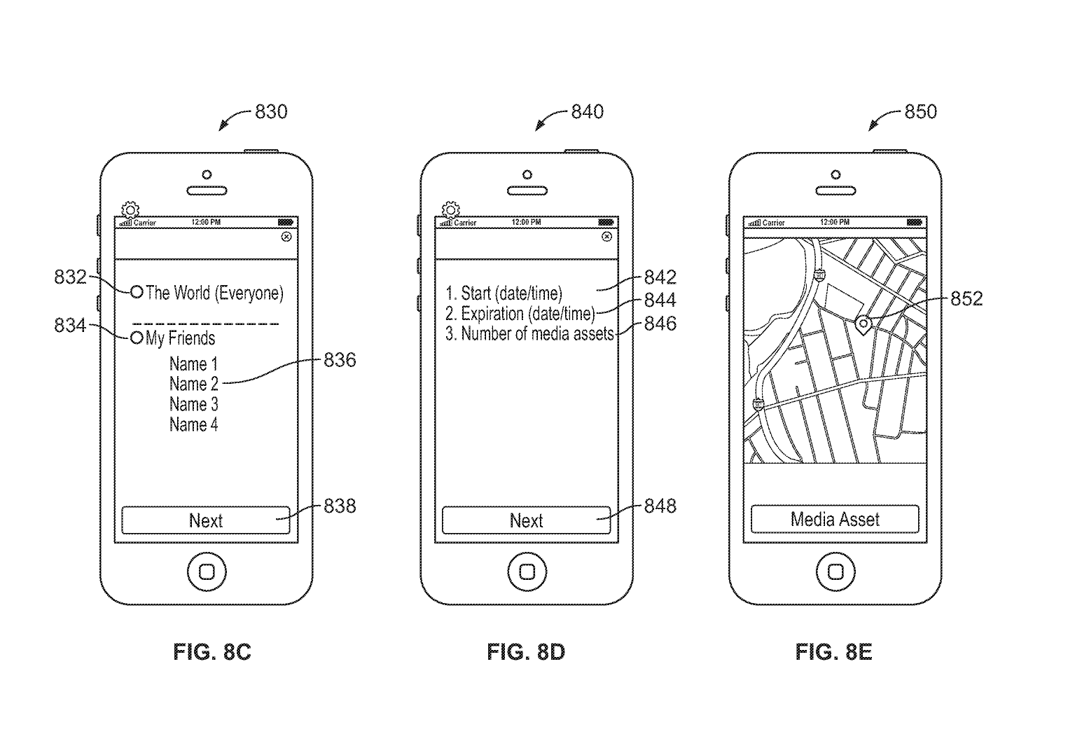

Turning now to FIGS. 8a-8e, example displays corresponding to the above flowchart 700 are provided. At FIG. 8a, an exemplary display of the application homepage 800 is detailed. The icon 810 allows the user to move the map to his or her current location, using the location features of the computing device. The user may select the OLLY icon 812 to create a new OLLY. The selection icon 814 will display a list of media assets received and left for others. Profile and setting adjustments can be made by selecting 804. The map can be adjusted, for example by filtering by location type, using 806. The filtering may include filtering by public type only, private type only, preferred contacts, content type, or other filtering mechanism to distinguish media assets. An address search or place name search can be conducted using the search bar 802, which, according to some embodiments, will reposition the map to the searched location.

At FIG. 8b, an exemplary display 820 for creating a new media asset 712 by selecting photo or video content is shown. The user may start the process selecting 822, and use the suite of features of the mobile device to capture a photo or video, which is then displayed at 826 upon selection. Alternatively, an existing file may be selected. In some embodiments, the media asset creation tools may include taking a photo, editing a photo, recording a video, recording audio, selecting existing media (either on the device or from a network), adding a message, drawing on a photo, formatting the type style, erasing a drawing, adding emoticons, or other content creation capabilities. When the desired content is shown, next 824 is selected to proceed to the selection of who should receive the media asset.

At FIG. 8c, an exemplary display 830 for selecting media asset recipient(s) is shown. The recipient may be set as the world 832, which makes the media asset publicly available to any user for collection at the specified geolocation. Or the user may prepare a private media asset by selecting recipients from a contact or friends list 834. By using shading, colors, and/or submenus, the application display can distinguish between contacts that have an existing account with the application, and contacts that may be invited to join. One or more recipients can be selected from the listed names 836.

At FIG. 8d, an exemplary display 840 for selecting additional parameters is provided. The parameter settings may allow configuration of a start date and time 842, expiration date and time 844, and number of media assets permitted to be collected 846 (for public media assets). In some embodiments, additional parameter settings may be provided, including the ability to configure notification settings, block particular contacts from sending media assets, set default geofence shape, enable predictive typing, enable predictive search, etc.

At FIG. 8e, an exemplary display 850 for selecting the location of the media asset is provided. A user may specify the location by moving a map pin 852 to mark the desired spot. Alternatively, the user may search for a specific address or place name, as discussed previously. According to some embodiments, the location may be further defined by shape selection or drawing tools to cover a broader area or specific region.

To provide aspects of the present invention, embodiments may employ any number of programmable processing devices that execute software, or stored instructions. Physical processors and/or machines employed by embodiments of the present invention for any processing or evaluation may include one or more networked (Internet, cloud, WAN, LAN, satellite, wired or wireless (RF, cellular, etc.), etc.) or non-networked general purpose computer systems, microprocessors, field programmable gate arrays (FPGAs), digital signal processors (DSPs), micro-controllers, smart devices (e.g., smart phones), computer tablets, handheld computers, and the like, programmed according to the teachings of the exemplary embodiments of the present invention, as is appreciated by those skilled in the computer and software arts. Appropriate software can be readily prepared by programmers of ordinary skill based on the teachings of the exemplary embodiments, as is appreciated by those skilled in the software art. In addition, the devices and subsystems of the exemplary embodiments can be implemented by the preparation of application-specific integrated circuits (ASICs) or by interconnecting an appropriate network of conventional component circuits, as is appreciated by those skilled in the electrical art(s). Thus, the exemplary embodiments are not limited to any specific combination of hardware circuitry and/or software.

Stored on any one or on a combination of computer readable media, the exemplary embodiments of the present invention may include software for controlling the devices and subsystems of the exemplary embodiments, for driving the devices and subsystems of the exemplary embodiments, for enabling the devices and subsystems of the exemplary embodiments to interact with a human user, and the like. Such software can include, but is not limited to, device drivers, firmware, operating systems, development tools, applications software, database management software, and the like. Such computer readable media further can include the computer program product of an embodiment of the present inventions for performing all or a portion (if processing is distributed) of the processing performed in implementing the inventions. Computer code devices of the exemplary embodiments of the present inventions can include any suitable interpretable or executable code mechanism, including but not limited to scripts, interpretable programs, dynamic link libraries (DLLs), Java classes and applets, complete executable programs, and the like. Moreover, parts of the processing of the exemplary embodiments of the present inventions can be distributed for better performance, reliability, cost, and the like.

Common forms of computer-readable media may include, for example, a floppy disk, a flexible disk, hard disk, magnetic tape, any other suitable magnetic medium, a CD-ROM, CDRW, DVD, any other suitable optical medium, punch cards, paper tape, optical mark sheets, any other suitable physical medium with patterns of holes or other optically recognizable indicia, a RAM, a PROM, an EPROM, a FLASH-EPROM, any other suitable memory chip or cartridge, a carrier wave or any other suitable medium from which a computer can read. Such storage media can also be employed to store other types of data, e.g., data organized in a database, for access, processing, and communication by the processing devices.

While the present invention has been described with reference to one or more particular embodiments, those skilled in the art will recognize that many changes may be made thereto without departing from the spirit and scope of the present invention. Each of these embodiments and obvious variations thereof is contemplated as falling within the spirit and scope of the invention. It is also contemplated that additional embodiments according to aspects of the present invention may combine any number of features from any of the embodiments described herein.

1. A system for location-based delivery of media assets, comprising:
a database containing a plurality of media assets;
a first computing device comprising a memory and one or more processors, the first computing device communicatively coupled to the database, the memory storing instructions that, when executed by the one or more processors, implement a method for preparing a media asset, said method comprising:
creating the media asset, wherein the media asset comprises audio, video, image, text, symbols, or a combination thereof;
receiving a selection of one or more recipients for the media asset, selected from a presented list of potential recipients;
receiving a selection of a geolocation for delivery of the media asset;
storing the media asset in the database;
a second computing device comprising a memory, a geolocation capability, and one or more processors, the second computing device communicatively coupled to the database, the memory storing instructions that, when executed by the one or more processors, implement a method for receiving a media asset, said method comprising:
determining, using the geolocation capability, a current location of the second computing device;
identifying, via communications with the database, one or more media assets associated with the current location; and
presenting the one or more media assets associated with the current location on the second computing device.

2. The system of claim 1, wherein the image is a photo and the text is a customized text message.

3. The system of claim 1, wherein the image is modified using an editing tool of the first computing device.

4. The system of claim 1, further comprising:
receiving, at the first computing device, a selection of a time and/or date associated with the media asset, wherein the media asset is stored in the database when the selected time and/or date is reached.

5. The system of claim 1, further comprising:
sending a notification, when the media asset is stored in the database, to the one or more recipients indicating that a media asset is available at the selected geolocation.

6. The system of claim 1, further comprising:
upon presenting the one or more media assets on the second computing device, sending a communication confirming delivery of the media asset to the first computing device.

7. The system of claim 1, further comprising:
upon presenting the one or more media assets on the second computing device, further presenting a quick reply feature on the second computing device allowing for a reply message to be prepared and sent to the first computing device.

8. The system of claim 1 wherein the first computing device and second computing device comprise mobile phones, and the method for preparing the media asset comprises a mobile application.

9. A method for creation and delivery of customized communications, comprising:
creating, on a first computing device, a customized communication comprising one or more of audio, video, image, symbol, or textual content;
receiving a selection of a geolocation for delivery of the customized communication;
storing the customized communication in a database;
determining, on a second computing device, a current location of the second computing device using a geolocation capability associated with the second computing device;
wherein the second computing device communicates with the database to determine if a customized communication is associated with the current location, and if so, presenting the customized communication associated with the current location on the second computing device.

10. The method of claim 9, further comprising:
receiving, on the first computing device, a selection designating the customized communication as anonymous, and a further selection indicating the number of recipients permitted to collect the anonymous customized communication at the selected geolocation.

11. The method of claim 9, further comprising:
receiving, on a first computing device, a selection of one or more recipients for the customized communication, selected from a presented list of potential recipients;

12. The method of claim 11, wherein a request to designate the customized communication as secret is received by the first computing device, and therefore no notification regarding the customized communication is provided to the one or more recipients until the one or more recipients arrive at the selected geolocation.

13. The method of claim 9, wherein the image is a photo and the textual content is a customized text message.

14. (canceled)

15. The method of claim 9, further comprising:
receiving, at the first computing device, a selection of a time and/or date associated with the customized communication, wherein the customized communication is stored in the database when the selected time and/or date is reached.

16. The method of claim 9, further comprising:
sending a notification, when the customized communication is stored in the database, to the one or more recipients indicating that the customized communication is available at the selected geolocation.

17. The method of claim 9, further comprising:
upon presenting the customized communication on the second computing device, sending a message confirming delivery of the media asset to the first computing device.

18. The method of claim 9, further comprising:
upon presenting the customized communication on the second computing device, further presenting a quick reply feature allowing for a reply message to be prepared and sent to the first computing device.

19. (canceled)

20. (canceled)

21. A system for location sensitive delivery of media assets, the system comprising:
a first mobile computing device executing a mobile application, wherein the mobile application is configured to create a media asset through the selection of content, contact, and geofence information relating to the created media asset;
a second mobile computing device executing a second instance of the mobile application, wherein the second instance of the mobile application is configured to deliver the media asset created on the first mobile computing device to the second mobile computing device only upon satisfaction of one or more delivery restrictions associated with the created media asset;
wherein the first mobile computing device and second mobile computing device are communicatively coupled via a communication network;
wherein the one or more delivery restrictions comprise at least the requirement that the second mobile device is currently located within the selected geofence for the created media asset.

22. The system of claim 21, wherein the one or more delivery restrictions further comprise a time restriction.

23. The system of claim 21, wherein a notification is provided, by the second instance of the mobile application to the second mobile computing device, that a created media asset is available along with disclosure of at least one delivery restriction, but without disclosure of the content of the created media asset until the one or more delivery restrictions are satisfied.
